(19) United States
(12) Patent Application Publication
(10) Pub. No.: US 2009/0019697 A1
(43) Pub. Date: Jan. 22, 2009

(54) Method for low lot gear manufacturing

(75) Inventor: Harry David Dodd, Morton, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/905,262

(22) Filed: Sep. 28, 2007

Related U.S. Application Data
(60) Provisional application No. 60/950,090, filed on Jul. 16, 2007.

(51) Int. Cl. B23P 15/14; B21D 53/28

(52) U.S. Cl. 29/893.3

(57) ABSTRACT

A method of fabricating a gear is disclosed. The method may include loading a donut blank onto a pallet through a bore in the donut bank. The method may further include loading the pallet and donut blank onto a plurality of different machines and performing a plurality of different machining processes on the donut blank to fabricate a gear.

### CROSS REFERENCE TO RELATED APPLICATION

This application is based upon and claims the benefit of priority from U.S. Provisional Application No. 60/950,090 to Dodd filed on Jul. 16, 2007, the entire contents of which are incorporated herein by reference.

### TECHNICAL FIELD

The present disclosure relates generally to a method of gear manufacturing, and more particularly, to a method of manufacturing gears in low lots.

### BACKGROUND

The manufacturing of gears normally includes a series of fabrication stations and machines used to perform various steps of the manufacturing process. These may include a forge, hobbing machines, chamfering machines, finishing machines, and any number of other machines for working with gears. For example, a gear blank may be forged at the beginning of the process, and moved from machine to machine, each machine performing a specific manufacturing process on the gear blank, and ultimately producing a finished gear.

A current method of manufacturing a gear involves forging a gear blank and then chucking that blank on an outside diameter while turning to semi-finish a central bore and one axial face. The gear may then be turned around and chucked on the internal bore to finish a second face. After the two axial faces are finished, the gear may be removed and chucked on the internal bore while the teeth slots are roughed by a hobbing machine. Following a lab check to ensure accuracy, the gear may be removed and chucked internally onto another machine for tooth finishing. Another lab check may follow and then the gear may be hardened by carborizing and quenching. The hardened gear may then be chucked on the tooth flanks using a pitch line chuck to hard finish the bore and faces.

One of the problems associated with such a method of manufacturing a gear is the tendency for alignment errors introduced by the multiple chucking, unchucking, and re-chucking of the gear blank to different machines. If the blank is not accurately chucked each time to preserve a commonly aligned axis, the bore and/or teeth may not be in concentric alignment with the gear blank, requiring the gear to be discarded as scrap metal, or if used in a machine, increasing the risk of machine malfunction and/or premature wear. Further, this inaccuracy requires the gear to be chucked on the tooth flanks using a pitch line chuck during bore and face finishing, since it cannot be assured that the outer diameter of the teeth will always be concentric with the teeth profile and/or the bore. Lastly, using this method of manufacturing a lot of custom gears may take as long as twelve weeks from receiving the specific order to shipping the custom manufactured gears.

One method of accelerating the manufacturing process and increasing production accuracy is U.S. Pat. No. 5,181,375 (the '375 patent) issued to Thurman et al., which discloses a method for producing gears. The method of the '375 patent includes forging a gear blank with roughly shaped teeth slots, and then performing various grinding operations to the tooth root and flank surfaces to produce a final finished shape. The method further includes grinding the teeth slots to their final finished profile before heat treating and hardening the gear. By completely grinding the teeth slots before heat treating the gear, the '375 patent seeks to reduce production time and relax any imposed stresses resulting from prior gear fabrication processes.

The method of the '375 patent may provide a manufactured gear in less time than previous methods, but the multiple grinding operations may increase the likelihood of alignment errors. Further, the multiple grinding operations may still require substantial non-value added time for work holding changes.

The disclosed method is directed to overcoming one or more of the problems set forth above.

### SUMMARY

In one aspect, the present disclosure is directed to a method of fabricating a gear. Specifically, loading a donut blank onto a pallet by chucking the pallet through a bore in the donut blank and then loading the pallet and donut blank onto various machines to shape the donut blank into a gear.

In another aspect, the present disclosure is directed to a method of manufacturing a gear. The method includes securing the outside diameter of a puck blank, turning a bore in the center of the puck blank to create a donut blank, chucking the donut blank through the bore to a pallet, loading the pallet on a turning machine and turning a axial face or a radial surface, and unloading the pallet from the turning machine.

In yet another aspect, the present disclosure is directed to a gear fabrication station for producing a gear from a donut blank. The gear fabrication station includes a pallet that mechanically secures the donut blank to allow machining on at least one axial face and a radial surface and a machine having a work-holding unit configured to mechanically secure the pallet to the machine.

In still another aspect, the present disclosure is directed to a gear fabrication station for producing a gear from a gear blank. The gear fabrication station includes an edge rounding station for edge rounding the intersection of teeth profiles and axial faces, wherein the edge rounding station includes a moving media bath.

### BRIEF DESCRIPTION OF THE DRAWINGS

FIG. 1 is a pictorial view of a bar stock and puck blank according to one embodiment of the disclosure;

FIG. 2 is a pictorial view of a puck blank manufactured according to one embodiment of the disclosure;

FIG. 3 is a pictorial view of a donut blank manufactured according to one embodiment of the disclosure;

FIG. 4 is a pictorial view of a gear blank manufactured according to one embodiment of the disclosure;

FIG. 5 is a pictorial view of an exemplary manufactured gear according to one embodiment of the disclosure; and

FIG. 6 is a flow chart of one embodiment of the disclosure.

### DETAILED DESCRIPTION

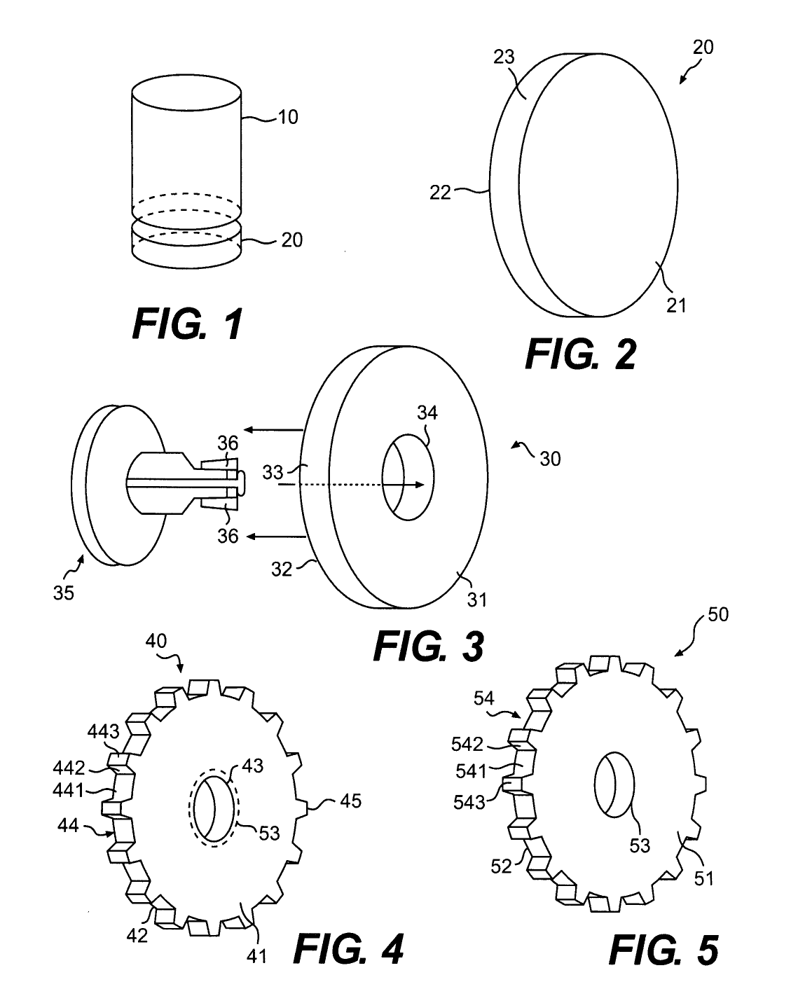

FIG. 1 illustrates a bar stock 10 from which a puck blank 20 may be cut using a saw (not shown) or any other method known in the art. Bar stock 10 may include a steel alloy cylinder of a predetermined size. The predetermined size may relate to the desired final dimensions of the manufactured gear 50 of FIG. 5. FIG. 2 illustrates puck blank 20. Puck blank 20 may include a first face 21, a second face 22, and an outer diameter 23.

FIG. 3 illustrates a donut blank 30. Donut blank 30 may include a first turned face 31, a second turned face 32, an outer diameter 33, and a standard bore 34. FIG. 3 also illustrates a pallet 35 according to one embodiment of the disclosure. Pallet 35 may include a mandrel which mechanically secures donut blank 30 or a gear blank 40 from within standard bore 34 by expanding one or more collets 36 in response to an applied force. The applied force may be provided by a spring, hydraulic system, manually, or any other method of applying force known in the art. Pallet 35 may further be adapted to be mechanically secured to a machine (not shown) to allow machining of donut blank 30 or gear blank 40. The machine may include a work table having a quick change system, clamp, or any other such work-holding unit known in the art. Pallet 35 may allow the donut blank 30 to be moved to a plurality of machines without the need to load and center the donut blank 30 each time. FIG. 4 illustrates a gear blank 40. Gear blank 40 may have a first face 41, a second face 42, a standard bore 43, a plurality of teeth slots 44, and an outer diameter 45. Teeth slots 44 may include a root 441, a flank 442, and an outer diameter 443.

FIG. 5 illustrates an exemplary manufactured gear 50 according to one embodiment of the disclosure. Gear 50 may include a first finished face 51, a second finished face 52, finished bore 53, and a plurality of finished teeth slots 54. Teeth slots 54 may include a root 541, a flank 542, and an outer diameter 543. As used herein, the term “gear” includes a structure having teeth slots 54 that transmit motion by a combination of rolling and sliding actions along flanks 542.

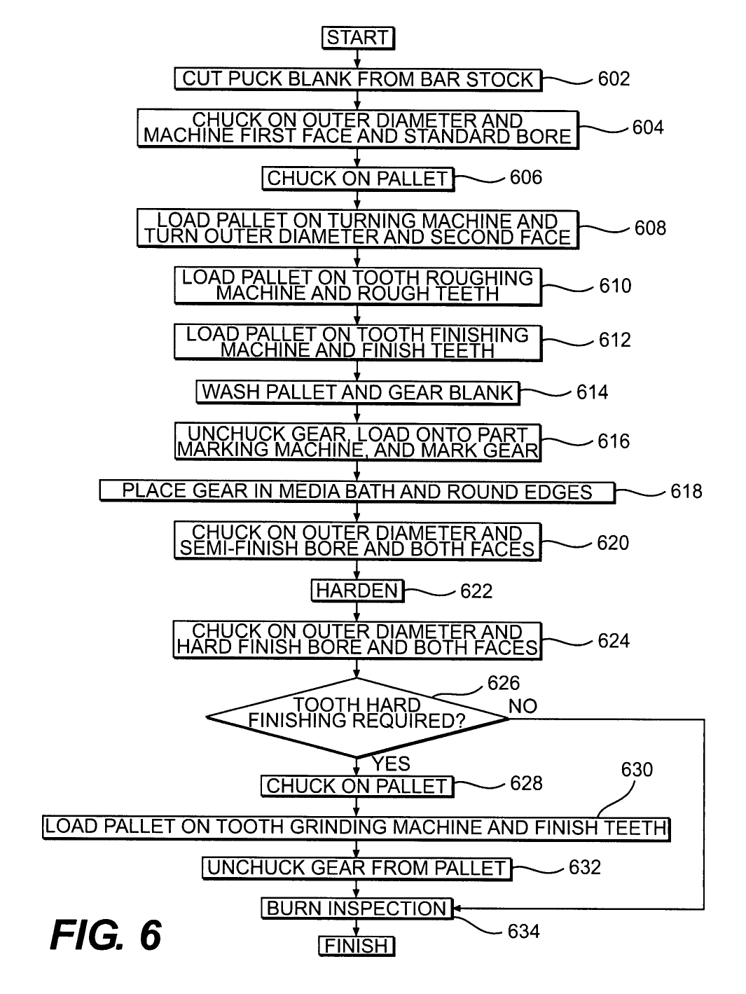

FIG. 6 illustrates steps of the disclosed gear manufacturing method. As shown, one may begin by cutting puck blank 20 from bar stock 10 (step 602). This puck blank 20 may then be chucked on the outer diameter 23 while a first face 21 may be machined and a standard bore 34 may be machined in the center of puck blank 20 to one of a plurality of standard cylinder process bores (step 604), thus creating donut blank 30. Donut blank 30, having a first turned face 31 and a standard center bore 34, may then be unchucked and moved to pallet 35 (step 606).

Pallet 35 may be configured to hold donut blank 30 from within standard bore 34, with first turned face 31 facing the pallet. Pallet 35, with donut blank 30 attached, may next be loaded onto a turning machine to turn outer diameter 33 and second turned face 32 (step 608). Pallet 35, with donut blank 30 attached, may then be unloaded from the turning machine and transferred to a tooth roughing machine (step 610).

Tooth roughing machine may first rough one tooth slot 44 with one or more of a small set of gashing cutters that may be positioned relative to the donut blank 30. After roughing one tooth slot 44, an in-process validation may be conducted to determine if the finishing stock envelope will be correct. An exemplary finishing stock envelope may be selected to balance the time required between the tooth roughing and the tooth finishing. If corrections are required, the corrections may be suggested to the operator by inspection software. The operator may then correct machine settings and continue with roughing all teeth slots 44. It may also be contemplated that teeth slots 44 may be roughed through a hobbing process or any other teeth roughing process known in the art. After all teeth slots 44 are roughed, a post process validation of the finishing stock envelope and tooth spacing may be measured to verify the expected results. If corrections are required for tooth spacing, the corrections may be suggested to the operator by the inspection software. Pallet 35 and gear blank 40 are then unloaded from the tooth roughing machine and loaded onto a tooth finishing machine (step 612).

The starting radial position for finishing teeth slots 44 may be automatically determined by the finishing stock envelope measured after the tooth roughing operation. One tooth slot 44 may be finished slightly short of the desired end size. After one tooth slot 44 is finished, an in process validation may be conducted to determine if flank 442 and slot 44 are correct in size, dimensions, and orientation. If the in process validation reveals that corrections may be required, the inspection software may suggest corrections to the operator. The operator may then accept and correct machine settings and continue with finishing all teeth slots 44. After all teeth slots 44 are finished, pallet 35 and gear blank 40 may then be unloaded from the tooth finishing machine.

Next, pallet 35 and gear blank 40 may be washed to remove any particles remaining from the previous machining operations (step 614). After washing, gear blank 40 may be removed from pallet 35 and transferred to a part marking machine (step 616). The operator may use the part marking machine to mark a part number on one of first or second finished face 41, 42. The part number may be stamped below root 441 of teeth slots 44.

Gear blank 40 may further be transferred to an edge rounding station where gear blank 40 may be placed into a moving media bath to edge round the intersection of flanks 442, roots 441, outer diameters 443, and first and second faces 41, 42 (step 618). In one exemplary aspect, the moving media bath may consist of a vibrating table which supports a spring mounted tub containing ceramic stones and a liquid, such as mild acid. The tub and table may vibrate rapidly in response to a moving eccentric weight attached to the table. As the tub and table vibrate, the mild acid may oxidize a thin layer of the gear blank 40, particularly on the gear edges. The oxidized layer may be worn away by repeated collisions with the ceramic stones moving in response to the vibration caused by the moving weight. Over the course of one hour and after many repeated collisions, the edges of the part may become sufficiently rounded.

After the edges have been rounded, gear blank 40 may be removed from the edge rounding station and chucked on outer diameter 45 (step 620). Bore 43 and at least one turned face 41, 42 may be soft machined to a pre-heat treat finished dimensions. Further, bore 43 and one of first and second turned faces 41, 42 may be semi-finished, thus creating finished bore 53 and one of finished first and second faces 51, 52. Gear blank 40 may then be un-chucked and then re-chucked with the other of first and second faces 41, 42 facing outward. The outward facing first or second face 41, 42 may then be semi-finished, creating the other of first and second finished faces 51, 52. After finished bore 53 and finished faces 51, 52 are semi-finished, a post process inspection may be conducted to confirm the correct size and form have been produced. Gear blank 40 may then be un-chucked and hardened by carborizing and quenching (step 622).

After the hardening process, gear blank 40 may again be chucked on outer diameter 45 on a machine that may hard turn and grind finished bore 53 and finished faces 51, 52 (step 624). Finished bore 53 and finished faces 51, 52 may then be rough machined by hard turning. After this hard turning, an in-process validation may be used to verify that the desired dimensions are correct. Further, finished bore 53 and finished faces 51, 52 may be finish ground and then inspected to confirm the correct size, form, and surface finish have been produced.

Next, if tooth hard finishing is required (step 626; yes), gear blank 40 may be reloaded onto pallet 35 (step 628) and pallet 35 may be loaded on to a tooth-grinding machine (step 630). One tooth slot 54 may be finished slightly short of the desired size and an in-process validation conducted to determine if tooth flank 542 will be correct. If the in process validation reveals that corrections may be required, the inspection software may suggest corrections to the operator. The operator may then accept and correct machine settings and continue with hard finishing all teeth slots 54. A post process inspection may then be conducted to confirm tooth form and spacing are within a specified range.

Pallet 35 may then be unloaded from the tooth-grinding machine (step 632) and transferred to an unchuck station where finished gear 50 may be removed from pallet 35 and washed. After being washed, gear 50 may be transferred to a burn inspection station (step 634). At the burn inspection station, teeth slots 54, finished bore 53 and finished faces 51, 52 may be inspected for grinder burn.

### INDUSTRIAL APPLICABILITY

The disclosed method for manufacturing gears may be applicable in any gear manufacturing facility where the ability to create custom sized gears quickly and accurately is desired. The disclosed method may provide custom manufactured gears in a consistent, waste-reducing, lower cost configuration.

According to the disclosed gear manufacturing method, the frequency of unchucking and rechucking donut blank 30 and gear blank 40 may be reduced, and based on the accuracy of finished gears 50 may be increased as alignment errors are reduced. Further, concentricity of outer diameter 45, teeth roots 441, teeth flanks 542, and bore 43 provided by the disclosed method, gear blank 40 may be chucked on outer diameter 45 rather than in teeth slots 44 during bore and face finishing. Further, because the disclosed method uses standard bore 34 and pallet 35 for securing donut blank 30 and gear blank 40 while transferring between various processes, the time elapsed from receiving a specific order to shipping the custom manufactured gears and may be reduced, along with a reduction in the cost of work-holding tooling.

It will be apparent to those skilled in the art that various modifications and variations can be made to the disclosed method. Other embodiments will be apparent to those skilled in the art from consideration of the specification and practice of the disclosed method. It is intended that the specification and examples be considered as exemplary only, with a true scope being indicated by the following claims and their equivalents.

What is claimed is:

1. A method of fabricating a gear, comprising:
loading a donut blank onto a pallet through a bore in the donut blank; and
loading the pallet and donut blank onto a plurality of different machines to perform a plurality of different machining processes on the donut blank.

2. The method of 1, wherein the machine is a turning machine.

3. The method of 2, wherein the machine is a tooth roughing machine.

4. The method of 3, wherein the plurality of different machines includes a finishing machine.

5. The method of 1, further including,
removing the donut blank from the pallet;
performing additional fabrication processes on the donut blank; and
reloading the donut blank onto the pallet for at least one more fabrication process.

6. A method of manufacturing a gear, comprising:
chucking an outside diameter of a puck blank;
cutting a bore into the center of the puck blank to create a donut blank;
securing the donut blank through the bore to a pallet;
loading the pallet on a turning machine;
turning at least one of an axial face and a radial surface; and
unloading the pallet from the turning machine.

7. The method of claim 6, further comprising:
loading the pallet onto a tooth roughing machine and roughing at least one tooth slot.

8. The method of claim 7, further comprising:
comparing the dimensions of at least one roughed tooth slot to the desired dimensions; and
roughing all the tooth slots based on the comparison.

9. The method of claim 6, further comprising:
loading the pallet on the tooth finishing machine and finishing at least one tooth slot.

10. The method of claim 9, further comprising:
comparing the dimensions of at least one finished tooth slot to the desired dimensions; and
finishing all the tooth slots based on the comparison.

11. The method of claim 9, further comprising:
unloading the pallet from the tooth finishing machine;
washing the pallet and attached gear blank;
decoupling the gear blank from the pallet;
loading the gear blank onto a part marking machine;
marking the gear blank with at least one identification number; and
placing the gear blank in a media bath to round edges of the teeth slots.

12. The method of claim 11, further comprising:
securing the gear blank on the outer diameter to turn the bore and at least one of the axial face; and
hardening the gear blank by carburizing and quenching.

13. The method of claim 12, further comprising:
securing the gear blank on the outer diameter to hard turn the bore and at least one of the axial face;
hard grinding the bore and at least one of the axial face and the radial surface;
decoupling the gear blank; and
securing the donut blank through the finished bore to the pallet.

14. The method of claim 13, further comprising:
loading the pallet onto the tooth grinding machine and grinding at least one tooth slot.

15. The method of claim 14, further comprising:
comparing at least one of the dimensions of the tooth slots to the desired dimensions; and
grinding all the teeth slots based on the comparison.

16. The method of claim 15, further comprising:
decoupling the pallet from the tooth grinding machine;
decoupling the gear from the pallet; and
inspecting of the gear for burn damage.

17. A gear fabrication station for producing a gear from a donut blank, comprising:
a pallet that mechanically secures the donut blank to allow machining on at least one of an axial face and a radial surface; and
a machine having a work-holding unit configured to mechanically secure the pallet to the machine.

18. The gear fabrication station of claim 17, wherein the pallet includes a mandrel configured to mechanically secure the donut blank from within a bore of the donut blank by at least one collet configured to be expanded in response to an applied force.

19. A gear fabrication station for producing a gear from a gear blank, comprising:
an edge rounding station for edge rounding the intersection of the teeth profiles and axial faces, wherein the edge rounding station includes a moving media bath.

20. The apparatus of claim 19, wherein the moving media bath consists of a vibrating tub containing elements suspended in a liquid configured to round the edges off of a gear.
